(19) United States
(12) Patent Application Publication
(10) Pub. No.: US 2002/0031660 A1
(43) Pub. Date: Mar. 14, 2002

(54) Embossed carrier tape, method of manufacturing the same and the metal molds used herein

(76) Inventors: Shozi Hashizume, Tokyo (JP); Yukio Nomura, Tokyo (JP)

Correspondence Address: Patent Group, Hutchins, Wheeler & Dittmar, 101 Federal Street, Boston, MA, 02110, US

(21) Appl. No.: 09/963,929

(22) Filed: Sep. 26, 2001

Related U.S. Application Data
(62) Division of application No. 09/470,069, filed on Dec. 22, 1999.

(30) Foreign Application Priority Data
Dec. 22, 1998 (JP) 363725/1998

(51) Int. Cl. B32B 7/12; B32B 15/04

(52) U.S. Cl. 428/343

(57) ABSTRACT

An embossed carrier tape, having a concave region (21a) for placing an electronic part on one surface (20a) and a convex region (21b) complementary to the concave region (21a) on a second surface (20b) is disclosed. The width (L2) at the top of the convex region (21b) is longer than the width (L1) of the opening of the concave region (21a), while the width (L1) of the opening of the concave region (21a) is longer than the width (L3) at the bottom. With this arrangement, when the embossed carrier tape 20 is vertically overlapped with the convex regions (21b) being oriented downward, the convex region (21b) of the upper embossed carrier tape (20) is unable to enter the concave region (21a) of the under embossed carrier tape.

### BACKGROUND OF THE INVENTION

1. Field of the Invention

The present invention relates to an embossed carrier tape with a structure for sealing a plurality of electronic parts one by one, and to an upper and an under metal mold that is used to subject the embossed carrier tape to a press treatment. It also relates to a method of press treating an embossed carrier tape using an upper and under metal mold.

2. Description of the Related Art

Accompanied with reductions in the cost, weight, and size of products (apparatus) and a large increase in the operating frequency, wherein the apparatus is comprised of field-effect transistors (FETs) and chip parts such as resistors and condensers (hereafter, called “electronic parts”), the electric parts have been fabricated to be lighter, thinner, and shorter. These small electronic parts are generally subjected to a taping process as described in JIS C 0806-1990 issued by Japanese Industrial Standard Committee, and then mounted on a product using automation. In recent years, the processes beginning with the fabrication of electronic parts through the taping are executed on the same floor of a clean room since the improvement in the accuracy of the electronic parts has also been needed. An example of the conventional embossed carrier tapes used under this background is illustrated in FIGS. 1(a) and 1(b) and FIGS. 2(a) and 2(b). The conventional embossed carrier tape of the first example in FIGS. 1(a) and 1b is made up of a carrier tape 1 and a bottom cover tape 2. As shown in FIG. 1(a), the carrier tape 1 has rectangular attachment holes 3 made in the lengthwise direction of the carrier tape 1. Each of circular feedholes 4 are formed on the peripheral region of the carrier tape 1 that is located along its width, and at the mid-section between the adjacent attachment holes 3 when the carrier tape 1 is viewed lengthwise. The bottom cover tape 2, as shown in FIG. 1(b), is pasted on the underside of the carrier tape 1, so as to cover the attachment holes 3. However, since the carrier tape 1 as shown in FIGS. 1(a) and 1(b) is made of a paper, the attachment holes 3 can be easily deformed when punching the attachment holes 3 and feedholes 4. Because of this, an electronic part may get caught in a deformed area. This causes the capability of the automated mounting process to be ruined. Moreover, scraps are easily generated by the punching of attachment holes 3 and feedholes 4. If the carrier tape 1 to which scraps have been clung is taken into the clean room, the fabrication environment becomes contaminated. In addition, if the scraps are caught between a part to be mounted and an attachment hole 3, the electric part cannot be mounted as usual onto the carrier tape 1, and the capability to perform the automated mounting of the taped parts may be ruined. Besides, since the attachment holes 3 are each formed to be a piercing hole, the bottom cover tape 2 is needed to close the underside of the respective attachment holes 3. Its structure, accordingly, is complex, and its costs tend to be high.

In order to solve the problems described above with the embossed carrier tape of the first conventional example as shown in FIGS. 1(a) and 1(b), an embossed carrier tape as shown in FIGS. 2(a) and 2(b) is often used. The embossed carrier tape 5 made of thermoplastic resin, as shown in FIGS. 2(a) and 2(b), is comprised of a plurality of rectangular embossed attachment holes 6 which are formed in a column and spaced at equal intervals, as well as a plurality of circular feedholes 7 formed in a column next to the respective embossed attachment holes 6 at the same intervals, as shown in FIG. 2(a). As shown in FIG. 2(b), each of the embossed attachment holes 6 are comprised of a concave area 6a on the surface 5a of the embossed carrier tape 5 and a convex area 6b on the underside 5b of the embossed carrier tape 5. The concave area 6a and the convex area 6b are both formed in a tapered sidewall. Since the embossed attachment holes 6 can be formed by simply stretching the material of the embossed carrier tape 5 of the conventional second example, the width L1 of each of the embossed attachment holes 6, on the same surface as the surface 5a of the embossed carrier tape 5, is longer than the width L2 of the convex area 6b on the top surface, as shown in FIG. 2(b). The reason for this will be described below while referencing to FIG. 3. The embossed attachment holes 6 are formed using an upper mold and an under mold with a rectangular parallelepiped concave area 9a. A sheet, which is the material used to manufacture the embossed carrier tape 5, is sandwiched between the upper mold 8 and the under mold 9, and the upper mold 8 is put into the concave area 9a of the under mold 9. As a result, the embossed carrier tape 5 as shown in FIG. 2(b) is formed. At this time, the embossed attachment holes 6 are formed along the length of the embossed carrier tape 5, in a format such that the metal mold clearance B is prepared between the outer surface of the upper mold 8 and the inner wall of the concave area 9a in the under mold 9. Since the material of the embossed carrier tape 5 is accordingly stretched at the metal mold clearance B, it becomes thinner and is formed in a tapered sidewall. As a result, the embossed carrier tape 5 is manufactured with the relationship of L1>L2 as described above. FIG. 4 shows a method resulting from improving the press treatment process for the embossed carrier tape 5 in FIG. 3. According to the improved method, the concave area 9a in the under mold 9 is formed in a tapered sidewall, and a pressure reduction suction hole 10 is prepared on the under mold 9. The embossed attachment hole 6 is formed on the embossed carrier tape 5 in such a manner that the sheet of the material is sucked along the surface of the under mold 9. However, since the method shown in FIG. 4 simply stretches the material in order to form the embossed attachment hole 6 in the same manner as the method as shown in FIG. 3, the thickness of the material around the embossed attachment hole 6 decreases. As a result, the aperture width L1 of the embossed attachment hole 6 on the same surface as the surface 5a of the embossed carrier tape 5 becomes longer than the width L2 of the outer circumference of the top surface of the convex region 6b. As shown in FIG. 5, when an electronic part 11 is placed inside the embossed attachment hole 6, the embossed attachment hole 6 is covered by a top cover tape 12. The embossed carrier tape 5 is then wound around a reel. The electronic part 11 is conveyed in such a format that the embossed carrier tape is wound in a roll. However, in the case of using the embossed tape 5 of the second conventional example shown in FIG. 2, due to its own weight, the convex area 5b of an upper embossed attachment hole 6 may be put inside the concave area 6a of an under embossed attachment hole 6 where the embossed attachment holes 6 overlap when the embossed carrier tape 5 is wound in a roll, as shown in FIG. 5. This emanates from that fact that there is the relationship of L1>L2 on the embossed carrier tape 5. Therefore, as shown in FIG. 5, the top cover tape 12 is compression-bonded on top of the electronic part 11 put in the under embossed attachment hole 6, whereas the embossed carrier tape is compression-bonded on its underside. The adhesion of the top cover tape 12 and the embossed carrier tape 5 to the electronic part 11 makes the automated mounting of the electric part 11 difficult. As shown in Table 1, as the storage time/temperature rises, the number of mounting failures of the electronic part 11 sharply increases due to such phenomenon as the adhesion of the top cover tape 12 and the embossed carrier tape 5 to the electronic part 11.

Next, an embossed carrier tape of the third conventional example disclosed in Japanese Patent Application Laid-open No. Hei 4-31260 is illustrated in FIG. 6. This embossed carrier tape is comprised of a carrier tape 13 and a cover tape 14. The carrier tape 13 is comprised of multiple pockets (embossed regions) 16, which are used to insert electronic parts 15. The cover tape 14 is connected to the carrier tape 13 so as to cover the multiple pockets 16, which is done, for example, by a thermo-compression bonding process. Adhesive regions 17 for the carrier tape 13 and cover tape 14, which are to be thermo-compression bonded, are formed to surround each pocket 16. This allows the possibility of a flexure in the cover tape 14 to be kept to a minimum. The embossed carrier tape is wound around a reel 18, and each reel 18 of electronic parts 15 is stored and transported as a one unit. However, according to the embossed carrier tape of the third conventional example described above, since the force necessary to peel the cover tape from the carrier tape 13 is not uniform, the peeling apart of the cover tape 14 from the carrier tape 13 may cause the carrier tape 13 to vibrate. In particular, in the case where small electronic parts are put in the carrier tape 13, the vibration caused by peeling off the cover tape 14 may cause some of the electronic parts to scatter. As a result of this, the capability to perform the automated mounting of the electronic parts is lowered.

### SUMMARY OF THE INVENTION

Accordingly, considering the above-mentioned problems with the conventional embossed carrier tapes, an embossed carrier tape of the present invention is provided lowering the percentage of defects when mounting the electronic parts using automation. Moreover, upper and under metal molds used to subject its embossed carrier tape to a press process, as well as a method of press-processing the embossed carrier tape using these upper and under metal molds are also provided.

According to a first aspect of the present invention, an embossed carrier tape is comprised of a concave region on the first surface, used in placing an electronic part, and a convex region complementary to said concave region on the second surface. Wherein, a cross section of said convex region and said concave region both have a trapezoidal profile. Wherein, the width at the top of the convex region or length L2 at the lowest end of the convex region 21b is longer than the width of the aperture of the concave region 21a or length L1 at the top of the convex region 21a, in the lengthwise direction of the embossed carrier tape (i.e., L1<L2). Width L5 at the top of the convex region 21b is longer than width L4 at the aperture of the concave region 21a, in the lengthwise direction of the embossed carrier tape (i.e., L4<L5). Due to this, the convex region of the upper embossed attachment hole is unable to enter the under embossed attachment hole as shown in FIG. 5. More importantly, the upper embossed carrier tape cannot pressure the top cover sheet which covers the under embossed attachment hole. This prevents adhesion of the top cover sheet to the electronic part that is placed inside of the under embossed attachment hole. Incidentally, the convex region and concave region are a tapered sidewall. That is, length L1 at the top of the concave region is longer than width L3 of the bottom of the concave region 21a (L3<L1) , whereas width L4 at the aperture of the concave region 21b is longer than width L6 at the bottom of the concave region 21a (L6<L4) . The tapered sidewall allows for more of an improvement in the precision of the dimensions of the convex and concave region in press treating the convex and concave region than that of a rectangular parallelepiped shape.

According to a second aspect of the present invention, an embossed carrier tape is comprised of a concave region on the first surface used in placing an electronic part. Wherein, the first surface and its underside, or the second surface, are flat. According to the second aspect of the present invention, since the second surface (e.g., the underside) of the embossed carrier tape is flat and does not include any convex regions, even when a convex region of the upper embossed carrier tape is vertically overlapped with a concave region of the under embossed carrier tape, the upper-overlapped embossed carrier tape is unable to enter the concave region of the under-overlapped embossed carrier tape. Therefore, tension cannot be imposed on each electronic part placed in each concave region of the under-overlapped embossed carrier tape. More importantly, a possible adherence to the top cover tape or the embossed carrier tape can be prevented. This causes a decrease in the percentage of defects during the automated mounting of electronic parts. The embossed carrier tape can be made of a thermoplastic resin including a conductive material. Alternatively, it can be made of a thermoplastic resin with its surface being coated with a film of a conductive material. Due to the embossed carrier tape made of a thermoplastic resin, even if the electronic parts to be attached in the respective concave regions are ones with a low withstand voltage such as a field effect transistor or a small part partially made of an insulating material, a possible defect caused by static electricity on the electric part to be mounted and a decrease in the automated mounting efficiency of electric parts can be prevented from occurring.

According to a third aspect of the present invention, A metal mold comprising an upper metal mold and an under metal mold, used for press treating an embossed carrier tape that is comprised of a concave region on the first surface for holding an electronic part therein, and a convex region on the second surface complementary to the concave region, are provided. Wherein, the upper metal mold is comprised of a planar region and a convex region that projects downward from the planar region, whereas the under metal mold is comprised of a planar region and a concave region on the planar region. The height of the convex region is longer than the depth of the concave region, and the length of the convex region on the same surface as the planar region of the upper metal mold is shorter than the length of the concave region on the bottom of the concave region. Usage of this structure of the upper and the under metal mold allows the formation of the aforementioned embossed carrier tape by a press treatment. The convex region and concave region can be formed to be a tapered sidewall. It is preferable that the temperatures of the upper and the under metal mold are set to a certain value by a temperature controller. If the temperature of the metal molds are lower than the softening point of the material, the concave shape on the embossed carrier tape may be unstably formed or not normally formed at all. Otherwise, if the temperatures of the metal molds are higher than the melting point of the material, it is hard to release the metal molds from the pressed material after being subjected to a press treatment. Due to this, if the embossed carrier tape is forcefully taken away from the metal molds, the shape of the concave region may be deformed. The temperatures of the metal molds accordingly need to be set to a value higher than the softening point of the material, but lower than the melting point of the material. A temperature controller can set the temperature of the upper and the under metal mold to the permissible value as described above so that the shape of the convex region on the embossed carrier tape can be formed with accuracy and certaincy.

According to a fourth aspect of the present invention, a method of press treating an embossed carrier tape is comprised of a step of press treating an embossed carrier tape using the aforementioned upper and under metal molds with their temperatures being kept higher than the softening temperature point of a material of said embossed carrier tape but lower than the melting point of the material. As described above, maintaining the temperature of the upper and the under metal mold to fall within the permissible range enables a formation of the normal shape of the concave region on the embossed carrier tape.

With the embossed carrier tape, according to the present invention, even when the embossed carrier tape is vertically overlapped, the upper-overlapped embossed carrier tape is unable to enter the embossed attachment hole of the under-overlapped embossed carrier tape. Accordingly, the load of the electronic part put in the embossed attachment hole of the upper-overlapped embossed carrier tape cannot be imposed on the electronic part put in the embossed attachment hole of the under-overlapped embossed carrier tape. As a result, the electronic part put in the embossed attachment hole of the embossed carrier tape cannot be attached to the undersurface of the top cover tape, which covers the bottom of the embossed attachment hole, or the embossed attachment hole. This prevents failures in the automated mounting of electronic parts caused by an attachment of the electronic parts to the bottom of the embossed attachment hole or the underside of the top cover tape. According to the upper and the under metal molds for a press treatment of an embossed carrier tape, according to the present invention, the embossed carrier tape with its results as described above can be fabricated. According to the method of press treatment of an embossed carrier tape of the present invention, the embossed attachment hole of the embossed carrier tape can be fabricated of even quality. Moreover, the releasing of the metal molds from the pressed material after being subjected to a press treatment can be done easily.

### BRIEF DESCRIPTION OF DRAWINGS

The above and other objects, features and advantages of the present invention will become more apparent from the following detailed description, when taken in conjunction with the accompanying drawings, wherein:

FIG. 1(a) illustrates an aerial view of the embossed carrier tape of the first conventional example, whereas FIG. 1(b) is a cross section cut along line AA in FIG. 1(a);

FIG. 2(a) illustrates an aerial view of the embossed carrier tape of the second conventional example, whereas FIG. 2(b) is a cross section cut along line AA in FIG. 2(a);

FIG. 3 is a cross section showing a state in manufacturing the embossed carrier tape of the second conventional example using metal molds;

FIG. 4 is a cross section showing a state in manufacturing the embossed carrier tape of the second conventional example using metal molds, which are different from the metal molds as shown in FIG. 3;

FIG. 5 is a cross section showing a state of vertically overlapping the embossed carrier tape in the format where electronic parts are put in their respective embossed attachment holes on the embossed carrier tape of the second conventional example as shown in FIG. 2.

FIG. 6(a) illustrates the embossed carrier tape of the third conventional example, which is wound around a reel;

FIG. 6(b) illustrates an aerial view of the embossed carrier tape of the third conventional example;

FIG. 6(c) is a horizontal cross section of it; and

FIG. 6(d) is a vertical cross section of it;

FIG. 7(a) is an aerial view of an embossed carrier tape, according to a first embodiment of the present invention;

FIG. 7(b) is a vertical cross section cut along a line AA in FIG. 7(a);

FIG. 7(c) is a horizontal cross section cut along line BB in FIG. 7(a);

FIG. 8 illustrates a cross section of an upper and an under metal mold used to manufacture the embossed carrier tape, according to the first embodiment of the present invention as shown in FIGS. 7(a) to 7(c);

FIG. 9 is a cross section showing a state of vertically overlapping the embossed carrier tape in the format where electronic parts are put in their respective embossed attachment holes on the embossed carrier tape of the first embodiment as shown in FIGS. 7(a), 7(b) and 7(c); and

FIG. 10(a) is an aerial view of an embossed carrier tape, according to a second embodiment of the present invention, whereas

FIG. 10(b) is a cross section cut along line AA in FIG. 10(a).

### DETAILED DESCRIPTION OF THE PREFERRED EMBODIMENTS

Hereafter, several embodiments of the present invention will be described in reference to the drawings.

(First embodiment)

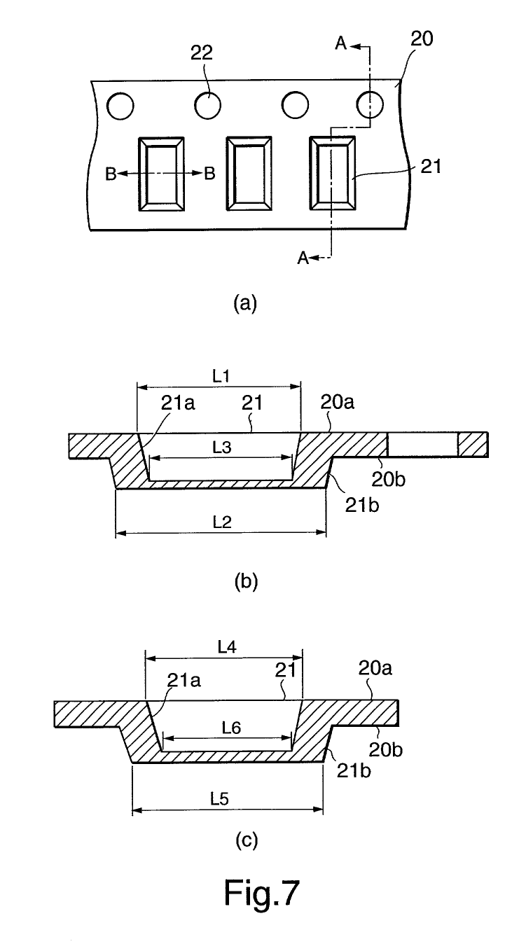

An embossed carrier tape, according to the first embodiment of the present invention, is illustrated in FIGS. 7(a), 7(b), and 7(c). FIG. 7(a) is an aerial view of the embossed carrier tape; FIG. 7(b) is a vertical cross section cut along a line AA in FIG. 7(a); and FIG. 7(c) is a horizontal cross section cut along a line BB in FIG. 7(a). As shown in FIG. 7(a), an embossed carrier tape of the first embodiment is made of thermoplastic resin, and is comprised of a line of multiple, square embossed attachment holes 21 formed at equal intervals and a line of multiple circular feedholes 22, which are formed to be next to the respective embossed attachment holes 21 at the same intervals. As shown in FIG. 7(b), each embossed attachment hole 21 has its own concave area 21a on the surface 20a of the embossed carrier tape 20, and its own convex area 21b on the underside 20b of the embossed carrier tape 20. These areas, concave area 21a and convex area 21b, are formed in a tapered sidewall. Each electronic part is placed in each embossed attachment hole 21. A feed mechanism (not shown in the figures) is meshed with each feedhole 22 and feeds the embossed carrier tape 20 at a fixed pace. The embossed carrier tape 20 of this embodiment is designed in such a manner that the width at the highest place of the convex area 21b or the length L2 at the bottom of the concave area 21b is longer than the width of the aperture of the concave area 21a or the length L1 at the top of the concave area 21a along the width of the embossed carrier tape 20. Moreover, the length L1 at the top of the concave area 21a is longer than the width L3 at the bottom of the concave area 21a. The concave area is formed in a tapered sidewall. Also, along the length of the embossed carrier tape 20, the width L5 at the highest place of the convex area 21b is longer than the width L4 of the aperture of the concave area 21a. Moreover, the width L4 of the aperture of the concave area 21a is longer than the width L6 of the bottom of the concave area 21a. The concave area is formed in a tapered sidewall. For the material comprising the embossed carrier tape 20, a single material sheet of thermoplastic resin such as polyvinyl chloride, polyethylene terephthalate, polystyrene, etc. is used. It is noted that, in the case where parts to be attached to the respective embossed attachment holes 21 are small ones made up of a device with low withstand voltage such as a field effect transistor (FET) and partially an insulating material, for preventing an occurrence of a possible breakup caused by the static electricity of each part and a decrease in capability to do automated mounting of the parts, which may be charged and thus adhered to other part, it is preferable that the embossed carrier tape 20 is made of thermoplastic resin that includes carbon, a titaniumoxide, etc., or thermoplastic resin with its surface being coated with a conductive material.

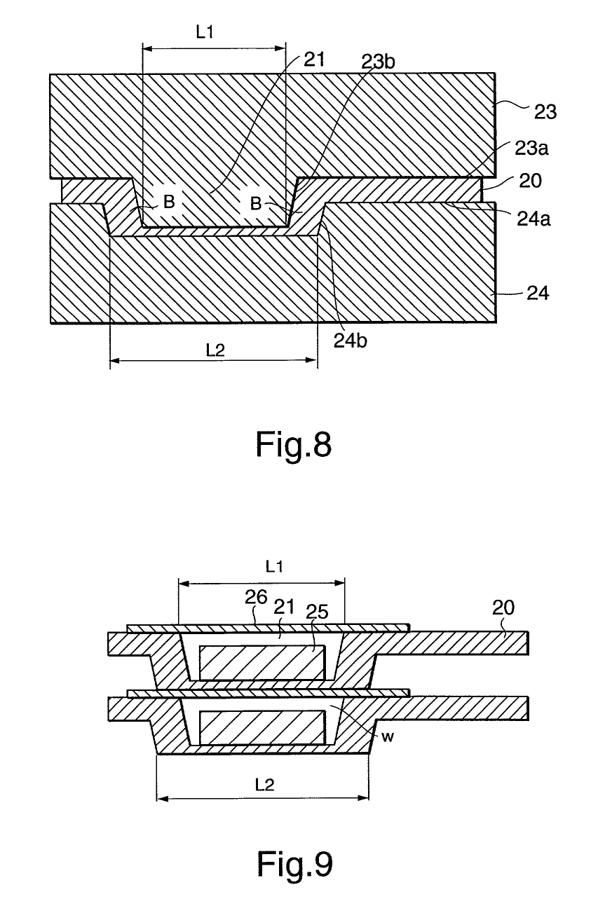

Next, a method of manufacturing the embossed carrier tape 20 of the first embodiment will be described. First, a sheet of thermoplastic resin is subjected to a slitting process or a press treatment that slits it into pieces, each having a fixed width. The embossed attachment holes 21 are then formed. FIG. 8 illustrates a vertical cross section of the metal molds, which are used to form the embossed attachment holes 21. The metal molds used to form the embossed attachment holes 21 are made of an upper metal mold 23 and an under metal mold 24. The upper metal mold 23 is made up of a planar region 23a and a tapered convex region 23b, which projects from the planar region 23a downward. On the other hand, the under metal mold 24 is made up of a planar region 24a and a tapered concave region 24b, which is formed on the planar region 24a. The height of the convex region 23b is set to be longer than the depth of the concave region 24b. Moreover, the length L1 of the convex region 23b on the same surface as the planar region 23a of the upper convex region 23b is set to be shorter than the length L2 of the concave region 24b on the bottom of the concave region 24b of the under metal mold 24 (i.e. L1<L2) . Each embossed attachment hole 21 is formed through a press treatment by the upper metal mold 23 and the under metal mold 24, each heated to a fixed temperature. The shapes of the respective upper metal mold 23 and under metal mold 24 are formed so that the press treatment (see FIG. 8) causes an expansion of the material, which is located at the region B (i.e., the region being sandwiched between the outer surface of the convex region 23b of the upper metal mold 23 and the inner wall of the concave region 24b of the under metal mold 24) inside the embossed attachment hole 21, toward the inner walls of the concave region 24b, and thus making the length L2 at the bottom of the convex region 21b become longer than the length L1 at the top of the concave region 21a, and also making the depth of the embossed attachment hole 21 become a little bit longer than the height of the part to be attached. The press treatment can be executed by a press apparatus with a feed-forward mechanism or can be executed by rotary-hammer forming with the assistance of metal molds in roller-form. It is noted that if the temperatures of the metal molds 23 and 24 are lower than the softening temperature point of the material, the shape of the embossed attachment hole 21 is unstable, and more importantly, the embossed attachment hole 21 is not able to be formed. In addition, if the temperatures of the metal molds 23 and 24 are higher than the melting point of the material, the pressed material cannot be easily released from the metal molds 23 and 24. This may cause a deformation in the shape of the embossed attachment hole 21. Accordingly, it is preferable that the temperatures of the metal molds 23 and 24 should be set higher than the softening temperature point of the material, but lower than its melting point. Moreover, it is preferable that, in order to keep the temperatures of the metal molds 23 and 24 within the above-mentioned temperature range, the temperatures of the metal molds 23 and 24 should be set to a predetermined temperature, and that a temperature controller should also be prepared so as to maintain the set temperatures. Thereafter, each feedhole 22 is formed through a punching process. At this time, in order to provide a high precision of dimensions of the embossed carrier tape 20 in its lengthwise direction, both ends of the embossed carrier tape 20 in its lengthwise direction (i.e., the upper and the lower end of the embossed carrier tape 20 in FIG. 7(a)) can be cut off through a press treatment. In addition, a detective hole (not shown in the figures), which is used to detect whether or not there is a part to be mounted, can be formed on the bottom of the embossed attachment hole 21. A top cover tape made of thermoplastic resin (not shown in the figures) is thermo-compression-bonded to the embossed carrier tape 20 fabricated through the aforementioned processes after each electronic part has been placed inside each embossed attachment hole 21. Thereafter, the resultant tape is wound without slack around a certain reel while applying tension. Each resultant reel is then stored or conveyed.

In the case where the embossed carrier tape, to which each electronic part is attached and to which the top cover tape is thermo-compression-bonded, is wound around a reel, the diameter of the wound reel gradually changes. This causes some of the embossed attachment holes to overlap with other ones at potentially several places in the reel. With the embossed carrier tape 20, according to the first embodiment of the present invention, and as shown in FIG. 7, even if some embossed attachment holes are overlapped with each other in the reel, since the aperture width L1 of the embossed attachment hole 21 is formed to be shorter than the bottom length L2 of the convex region 21b as shown in FIG. 9, the application of tension to the reel while winding does not cause the convex region 21b of the upper-overlapped embossed attachment hole 21 to enter the concave region 21a of the under-overlapped embossed attachment hole 21. Therefore, since there is a certain gap W between the electronic part 25 that is put in the embossed attachment hole and the undersurface of the top cover tape 26 which covers each embossed attachment hole 21 and is bonded, no tension is applied to any of the electronic parts 25. While transporting the reels by a truck, etc., their temperature may go above 60° C. Even at high temperatures, according to the present invention, pressuring electronic parts 25 wound around each reel cannot cause the part 25 to cling with the bottom of an embossed attachment hole 21 or the top cover tape 26. Therefore, the capability to perform the automated mounting of the electronic parts 25 is maintained. Moreover, according to the present invention, the usage of a sheet of thermoplastic resin for the embossed carrier tape 20 and top cover tape 26 prevents the contamination by debris such as scraps generated by the press treatment process, thus preventing this contamination from making the attachment of the electronic parts 25 to the embossed carrier tape 20 difficult, and also preventing a deterioration in the capability to perform the automated mounting of electronic parts 25.

(Second embodiment)

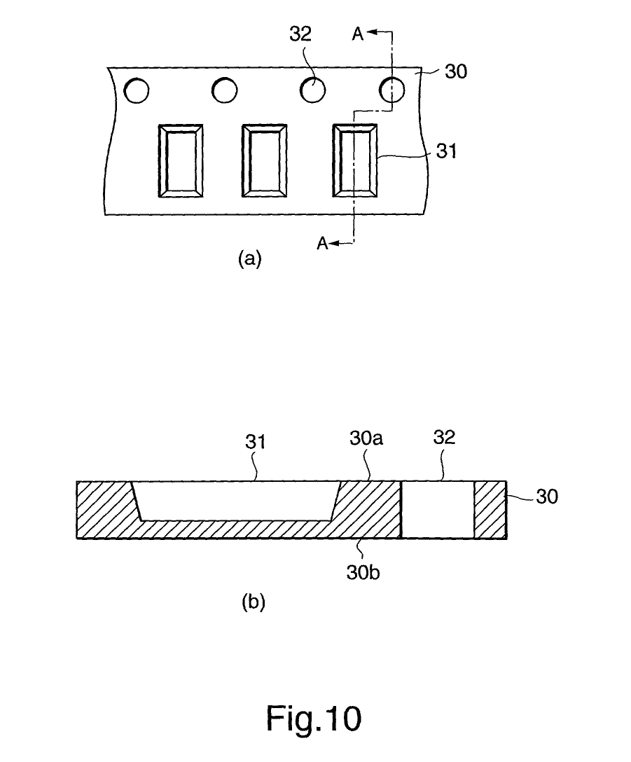

FIGS. 10(a) and 10(b) illustrate an embossed carrier tape, according to the second embodiment of the present invention. FIG. 10(a) shows its aerial view, whereas FIG. 10(b) shows a vertical cross section cut along line AA in FIG. 10(a). As shown in FIG. 10(a), an embossed carrier tape 30 of this embodiment is made of thermoplastic resin, and is comprised of a line of multiple, square embossed attachment holes 31 formed at equal intervals and a line of multiple, circular feedholes 32, which are formed to be next to the respective embossed attachment holes 31 at the same intervals. As shown in FIG. 10(b), each embossed attachment hole 31 has its own concave area on the surface 30a of the embossed carrier tape 30. The depth of the embossed attachment hole 31 is shorter than the thickness of the embossed carrier tape 30. That is, the embossed carrier tape 30 of this embodiment does not have a convex region on the underside of the embossed carrier tape 30, unlike the embossed carrier tape 21 of the first embodiment, but has a planar underside 30b. Each electronic part (not shown in the figures) is placed in each embossed attachment hole 31. A feed mechanism (not shown in the figures) is meshed with each feedhole 22 and feeds the embossed carrier tape 30 at a fixed pace. For the material comprising the embossed carrier tape 30, a single material sheet of thermoplastic resin such as polyvinyl chloride, polyethylene terephthalate, or polystyrene is used as in the same manner as in the first embodiment. It is noted that there are cases where the parts to be attached to the respective embossed attachment holes 31 are small ones containing a device with a low withstand voltage such as a field effect transistor (FET) and partially containing an insulating material used for preventing a possible breakup caused by the static electricity of each part and also used to prevent a decrease in the capability to perform the automated mounting of the parts, which may be charged and thus adhere to other parts. In this case it is preferable that the embossed carrier tape 30 be made of a thermoplastic resin that includes a conductive material such as carbon and a titanium oxide, or a thermoplastic resin with its surface being coated with a conductive material.

Next, a method of manufacturing the embossed carrier tape 30 of the second embodiment will be described. First, a sheet of thermoplastic resin is subjected to a slitting process or a press treatment into pieces, each having a fixed width. The embossed attachment holes 31 are then formed. The attachment holes 31 can be formed by a press molding using an upper and an under metal mold that are heated to a fixed temperature, in the same manner as in the first embodiment. The shapes of the respective upper and under metal molds are formed so that the press treatment process causes an expansion of the part of the material complementary to the attachment hole 31 along the surface of the sheet of material, so as to make the bottom of the embossed attachment hole 31 become flat, and also causing the depth of the attachment hole 31 to become a little bit longer than the height of part to be attached. It is preferable that the press treatment be executed by rotary-hammer molding with the assistance of metal molds in roller form. It is noted that if the temperatures of the metal molds are lower than the softening temperature point of the material, the shape of the attachment hole 31 is unstable, and more importantly, the embossed attachment hole 31 is not able to be formed. In addition, if the temperatures of the metal molds are higher than the melting point of the material, the pressed material cannot be easily released from the metal molds. This may cause a deformation in the shape of the embossed attachment hole 31. Accordingly, it is preferable that the temperatures of the metal molds be set higher than the softening temperature point of the material, but lower than the melting point of the material. Thereafter, each feedhole 32 is formed through a punching process. At this time, in order to provide a high precision of dimensions of the embossed carrier tape 30 in its lengthwise direction, both ends of the embossed carrier tape 30 along its width (i.e., the upper and the lower end of the embossed carrier tape 30 in FIG. 10(a)) can be cut off through a press treatment. In addition, a detective hole (not shown in the figures), which is used to detect whether or not there is part to be mounted, can be formed on the bottom of the embossed attachment hole 31. A top cover tape made of thermoplastic resin (not shown in the figure, refer to top cover tape 26 in FIG. 9) is thermo-compression-bonded to the embossed carrier tape 30 fabricated through the aforementioned processes after each electronic part has been placed inside each embossed attachment hole 31. Thereafter, the resultant tape is wound without slack around a certain reel while applying tension (i.e., the winding tension). Each resultant reel is then stored or conveyed.

With the embossed carrier tape 30, according to the second embodiment of the present invention, even if some embossed attachment holes 31 are overlapped with each other in the reel, the application of a winding tension does not cause the bottom of the upper overlapped attachment hole 31 of the embossed carrier tape 30 to enter the inside of the under overlapped attachment hole 31. This is the same as the embossed carrier tape 20 of the first embodiment as shown in FIG. 9. Therefore, there is no application of tension to each attached electronic part. Due to this, even while transporting the reels by a truck, etc., with their temperature being beyond 60° C., the pressuring of the electronic parts wound around each reel cannot cause the parts to cling to the embossed carrier tape 30 or the top cover tape, and above all preventing a deterioration in the capability to perform the automated mounting of the electronic parts.

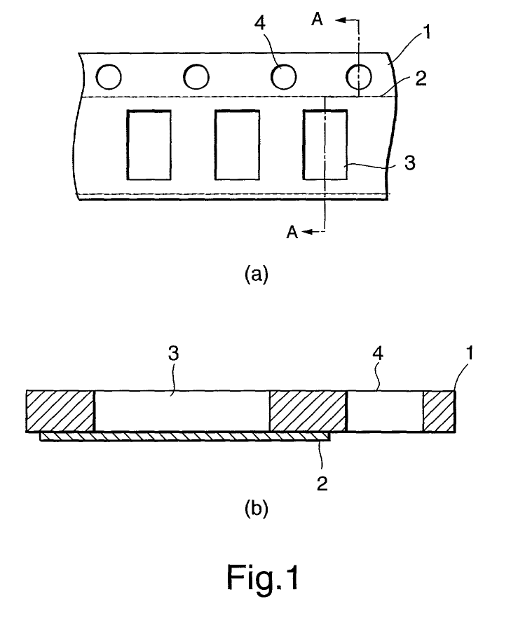

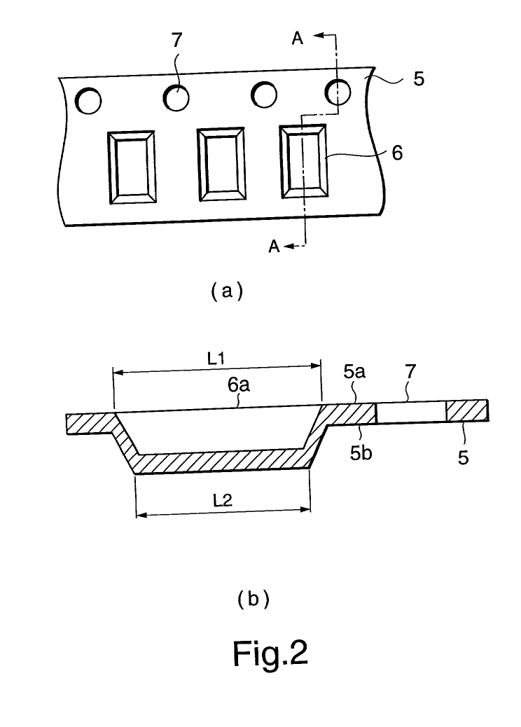

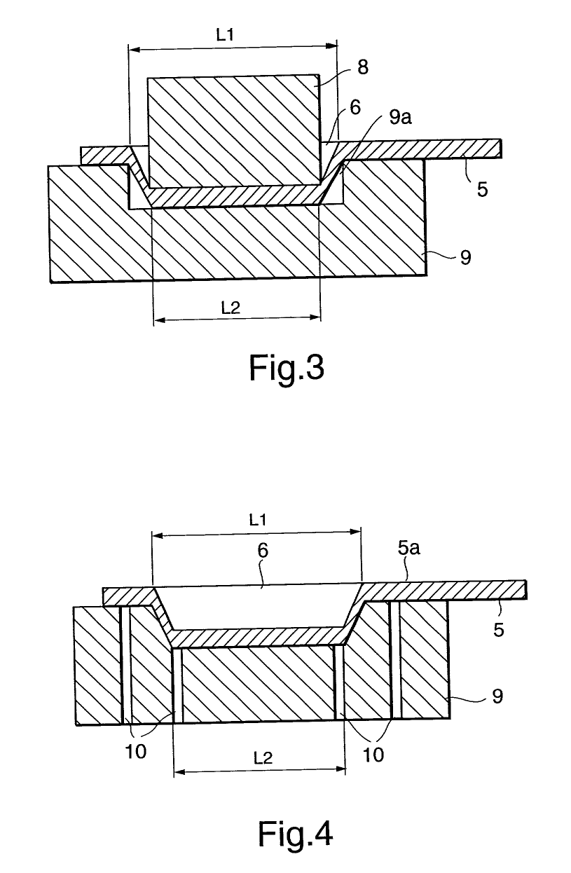

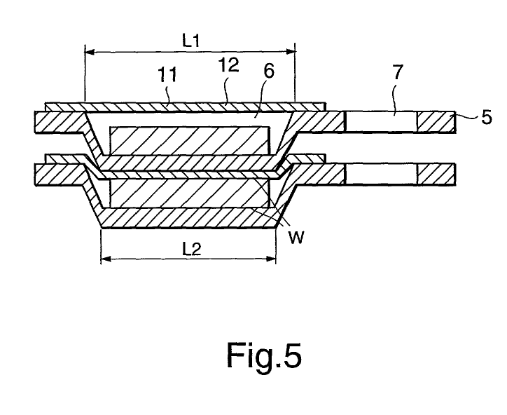

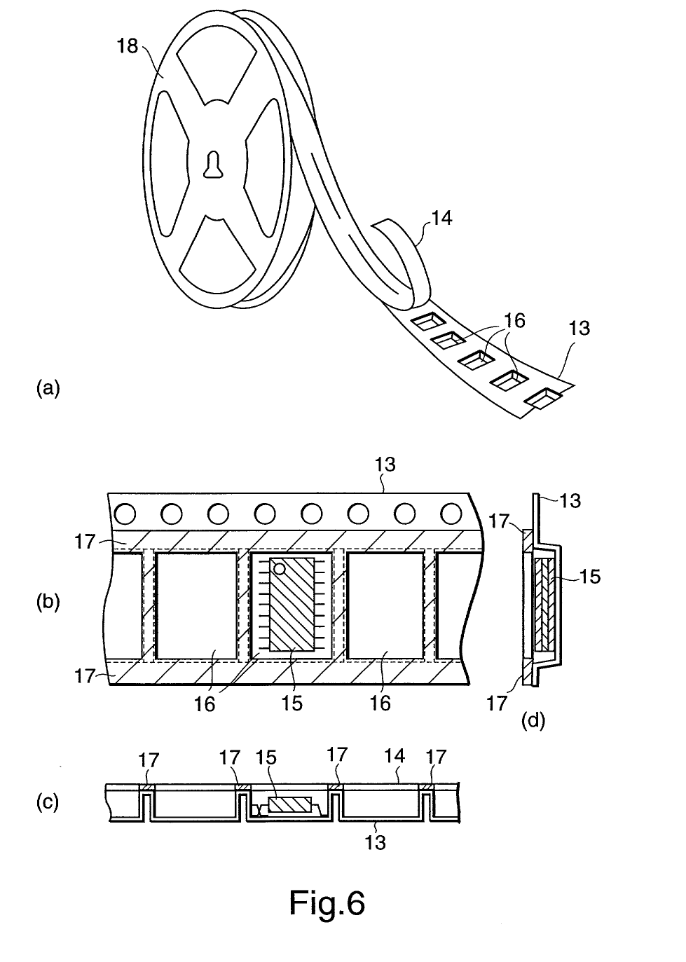

Table 1 shows the comparison of the capabilities of the automated mountings of electronic parts among different embossed carrier tapes: The embossed carrier tapes 20 and 30 with the parts to be mounted being field effect transistors (1.0×0.5×0.5 mm in size); and The conventional tapes that are disclosed in JIS C 0806-1990 (see FIGS. 1 and 2)

TABLE 1

| | Number of automatic mounting failures of | | | |
|---|---|---|---|---|
| | electronic parts in a general storage | | | |
| | environment (number of tested samples: 100,000) | | | |
| | 3 months at | 168 | 168 | 168 |
| Embossed carrier tape | normal temperature | hours | hours | hours |
| type | and humidity | 50° C. | 60° C. | 70° C. |
| first embodiment | 0 | 0 | 1 | 3 |
| (FIG. 7) | | | | |
| second embodiment | 0 | 0 | 2 | 4 |
| (FIG. 8) | | | | |
| square hole punched | 22 | 31 | 40 | 103 |
| tape (FIG. 1) | | | | |
| embossed carrier | 13 | 20 | 230 | 500 |
| tape (FIG. 2) | | | | |

The values in Table 1 are obtained by counting the number of parts to be mounted (i.e., field effect transistors) that have adhered to the bottom of the embossed attachment holes or the underside of the top cover tape after 100,000 samples of parts to be mounted have been stored for 3 months, 168 hours, 168 hours, and 168 hours at the respective normal temperature, 50° C., 60° C., and 70° C. As shown in Table 1, in the most inhospitable condition where the storage temperature is equal to 70° C. and the storage time is equal to 168 hours, the embossed carrier tapes, according to the first and the second embodiment, respectively, of the present invention, had far fewer automatic mounting defects than the conventional embossed carrier tapes. Moreover, since the number of defects does not increase sharply as the temperature rises, it is apparent that the embossed carrier tapes, according to the present invention, are superior than the conventional ones.

Embossed carrier tapes, their manufacturing methods and the metal molds used herein, according to the present invention, have been described in connection with certain preferred embodiments. It is to be understood that the subject matter encompassed by the present invention is not limited to these specific embodiments. On the contrary, it is intended to include all alternatives, modifications, and equivalents as can be included within the spirit and scope of the following claims.

What is claimed is:

1. An embossed carrier tape comprising: a first surface having a concave region for holding an electronic part therein, said concave region having a first width at an opening portion and a second width at a bottom portion of said concave region; a second surface having a convex region complementary to said concave region; wherein said first width is larger than said second width, and a width at a most protruded part of said convex region is larger than said first width.

2. The embossed carrier tape, according to claim 1, wherein a cross section of said convex region and said concave region both have a trapezoidal profile.

3. The embossed carrier tape, according to claim 1, wherein said convex region and said concave region both have a tapered sidewall.

4. The embossed carrier tape, according to claim 1, wherein said width at a most protruded part of said convex region, said first width, and said second width are in the widthwise direction of said embossed carrier tape.

5. The embossed carrier tape, according to claim 1, wherein said width at a most protruded part of said convex region, said first width, and said second width are in the lengthwise direction of said embossed carrier tape.

6. An embossed carrier tape comprising: a first surface having first and second concave regions for holding electronic parts therein, said concave regions having a first width at an opening portion and a second width at a bottom portion of said concave regions, respectively; a second surface having first and second convex regions complementary to said first and second concave regions, respectively; wherein said first width is larger than said second width, and when said embossed carrier tape is stacked vertically so that said first convex region is disposed on said second concave region, said first convex region is unable to enter said second concave region.

7. An embossed carrier tape, comprising: a first surface having a concave region for holding an electronic part; a second surface opposing said first surface; wherein said second surface is substantially flat.

8. The embossed carrier tape, according to claim 1, wherein said embossed carrier tape is made of a thermoplastic resin including a conductive material.

9. The embossed carrier tape, according to claim 6, wherein said embossed carrier tape is made of a thermoplastic resin including a conductive material.

10. The embossed carrier tape, according to claim 7, wherein said embossed carrier tape is made of a thermoplastic resin including a conductive material.

11. The embossed carrier tape, according to claim 1, wherein said embossed carrier tape is made of a thermoplastic resin with its surface being coated with a film of a conductive material.

12. The embossed carrier tape, according to claim 6, wherein said embossed carrier tape is made of a thermoplastic resin with its surface being coated with a film of a conductive material.

13. The embossed carrier tape, according to claim 7, wherein said embossed carrier tape is made of a thermoplastic resin with its surface being coated with a film of a conductive material.

14. A metal mold comprising an upper metal mold and an under metal mold, for press-treating an embossed carrier tape comprising a first surface having a concave region for holding an electronic part therein and a second surface having a convex region complementary to said concave region, said upper metal mold comprising a planar region and a convex region that projects downward from said planar region, said under metal mold comprising a planar region and a concave region on said planar region, wherein a height of said convex region is larger than a depth of said concave region, and a width of said convex region on the same surface as said planar region of the upper metal mold is smaller than a width of said concave region at the bottom of said concave region.

15. The upper and the under metal mold, according to claim 14, wherein said convex region and said concave region both have a tapered sidewall.

16. The upper and the under metal mold, according to claim 14, wherein the temperatures of said upper and said under metal mold are set to a certain value by a temperature controller.

17. The upper and the under metal mold, according to claim 15, wherein the temperatures of said upper and said under metal mold are set to a certain value by a temperature controller.

18. A method of press-treating an embossed carrier tape using an upper and an under metal mold, said embossed carrier tape comprising a first surface having a concave region for holding an electronic part therein and a second surface having a convex region corresponding to said concave region, said upper metal mold comprising a planar region and a convex region that projects downward from said planar region, said under metal mold comprising a planar region and a concave region on said planar region, a height of said convex region is larger than a depth of said concave region, and a width of said convex region on the same surface as said planar region of the upper metal mold is smaller than a width of said concave region at the bottom of said concave region, said method comprising press-treating an embossed carrier tape using said upper and said under metal mold with their temperatures being kept higher than softening temperature of a material used for said embossed carrier tape, and lower than a melting point of said material.

19. A method of press treating an embossed carrier tape, according to claim 18, wherein said convex region and said concave region both have a tapered sidewall.
